(19) United States
(12) Patent Application Publication
(10) Pub. No.: US 2008/0012446 A1
(43) Pub. Date: Jan. 17, 2008

(54) Motor with brush

(76) Inventor: Makoto Akabane, Suwa-gun (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/827,262

(22) Filed: Jul. 11, 2007

(30) Foreign Application Priority Data
Jul. 12, 2006 (JP) JP 2006-191280

(51) Int. Cl. H02K 13/00

(52) U.S. Cl. 310/233; 310/248

(57) ABSTRACT

A motor with a brush having a rotor, a commutator, a brush and a stationary side member is provided. The commuator is rotatable with the rotator and the stationary side member retains a base end side of the brush in such a manner that a top end side of the brush elastically contacts an outer circumference surface of the commutator, and retains a permanent magnet in such a manner that the permanent magnet faces the rotor. The brush is equipped with a bent part on a way from the base end side toward the top end side, as well as a damper member fixed to both the bent part of the brush and the stationary side member.

### FIELD OF THE INVENTION

The present invention relates to a motor with a brush in which commutation is carried out by a commutator and a brush.

### BACKGROUND

In a motor with a brush, commutation is carried out by making a metallic brush elastically contact an outer circumference surface of a commutator that can rotate together with a rotor. A base end side of the brush is fixed to a brush holder, while a halfway position of the brush bends on a way from the base end side toward a top end side and the top end side contacts the outer circumference surface of the commutator. In a case of such a motor with a brush, mechanical noise is generated when the top end side of the brush violently vibrates according to a rotation of the rotor (a rotation of the commutator). Then, it is proposed that an adhesive compound material made of a water-soluble acrylic emulsion, whose initial viscosity is adjusted by a polymerization reaction of styrene monomer, is applied to an outside of a base part of the brush and its neighboring part in order to make up a damper member for the purpose of improving a vibration damping performance of the brush, as disclosed in Japanese Unexamined Patent Publication (Kokai) No. 2000-224816.

### SUMMARY OF THE INVENTION

Regarding such a motor with a brush, since a further reduction in mechanical noise and a longer product lifetime are requested in recent years, an improvement in the vibration damping performance of the brush is further requested. However, there is a problem that placing a damper member only at a base end of the brush and its adjacent section as shown in a structure disclosed in above Japanese Unexamined Patent Publication (Kokai) No. 2000-224816 does not comply with such a request.

Thus, the inventor of the present invention proposes a further improvement in the vibration damping performance of the brush through optimal placement of the damper member by making use of a condition where the brush is equipped with a bent part and a stationary member including a brush holder, a case, and so on is located around the brush.

That is to say; a problem of the present invention is to propose a structure with which it is possible to improve the vibration damping performance of the brush through placement of the damper member in a further optimal condition, in a motor equipped with the brush that bends on a way from a base end side toward a top end side.

To solve the problem identified above, in the present invention; a motor with a brush includes: a rotor; a commutator that is rotatable together with the rotor; a brush; and a stationary side member that retains a base end side of the brush in such a manner that a top end side of the brush elastically contacts an outer circumference surface of the commutator, and furthermore retains a permanent magnet in such a manner that the permanent magnet faces the rotor; wherein the brush is equipped with a bent part on a way from the base end side toward the top end side, as well as a damper member fixed to both the bent part of the brush and the stationary side member.

In the present invention; the damper member is placed for the brush, and the damper member is fixed to both the bent part of the brush and the stationary side member. Therefore, even when the top end side of the brush vibrates according to a rotation of the rotor (a rotation of the commutator), vibration of the brush can be damped efficiently. Accordingly, mechanical noise generated due to the vibration of the brush can be reduced. Furthermore, abrasion of the brush and the commutator can be so controlled that a product lifetime of the motor with the brush can be elongated. When a case where the damper member is fixed to both the bent part of the brush and the stationary side member is compared with another case where the damper member is fixed only to an outside of the base part of the brush and its neighboring part, it is possible for the former case to significantly improve a vibration damping performance of the brush. As a reason for the effect, it is considered that; vibration of the brush that occurs at a plurality of frequency ranges is effectively prevented by elasticity of the damper member fixed to the bent part of the brush as well as elasticity of the damper member existing between the bent part of the brush and the stationary side member, in addition to elasticity that the brush itself has and elasticity that the bent part of the brush has.

In the present invention; it is preferable that the damper member is fixed to both an inside and an outside of the bent part. When the structure described above is compared with a case where the damper member is fixed only to one of an inside and an outside of the bent part, it is possible for the structure described above to significantly improve a vibration damping performance of the brush and to reduce mechanical noise generated due to the vibration of the brush and furthermore to control abrasion of the brush and the commutator. Namely, it is considered that; when the damper member is fixed to both the inside and outside of the bent part, a part of the damper member fixed to the inside of the bent part and another part of the damper member fixed to the outside of the bent part each carry out compression and extension so as to control vibration of the damper member according to each displacement in a direction with which the bent part opens and another direction with which the bent part closes.

In the present invention; it is also possible to adopt a structure in which the damper member is fixed to the inside of the bent part. Being compared with the case where the damper member is fixed only to the outside of the base part of the brush and its neighboring part, the structure described above can also improve a vibration damping performance of the brush.

In the present invention; it is also possible to adopt a structure in which the damper member is fixed to the outside of the bent part. Being compared with the case where the damper member is fixed only to the outside of the base part of the brush and its neighboring part, the structure described above can also improve a vibration damping performance of the brush.

In the present invention; the damper member is one of a resin-base elastic compound and a rubber-base elastic compound that is applied so as to cover up both the bent part and the stationary side member, and then hardened.

In the present invention; it is preferable that the stationary side member includes at least a brush holder to retain the base end side of the brush and a case to retain the permanent magnet, and the damper member is fixed to the brush holder of the stationary side member.

In the present invention; it is preferable that the brush holder is equipped with a slit to fix the base end side of the brush, and the damper member is fixed to an inlet part of the slit of the brush holder.

In the present invention; it is preferable that the slit is extended linearly according to a shape of the base end side of the brush, and a wall surface at an outside of the inlet part of the slit is formed to be a curved wall surface according to a shape of the bent part, and the damper member is fixed to the curved wall surface of the brush holder.

In a motor with a brush according to the present invention, a damper member is placed for the brush, and the damper member is fixed to both a bent part of the brush and a stationary side member. Therefore, even when a top end side of the brush vibrates according to a rotation of a rotor (a rotation of a commutator), vibration of the brush can be damped efficiently. Accordingly, mechanical noise generated due to the vibration of the brush can be reduced so as to materialize a silent unit and furthermore a non-energizing time can be eliminated. Moreover, abrasion of the brush and the commutator can be so controlled that a product lifetime of the motor with the brush can be elongated.

### BRIEF DESCRIPTION OF THE DRAWINGS

FIG. 1 is a cross-sectional drawing to show a general structure of a motor with a brush to which the present invention is applied.

FIG. 2A, FIG. 2B, and FIG. 2C are a plan view drawing and a sectional drawing of a brush and a brush holder extracted from the motor with the brush that FIG. 1 shows, as well as an explanatory drawing of a sliding surface of the brush and the commutator in the motor with the brush that FIG. 1 shows, in due order.

FIG. 3A and FIG. 3B are explanatory drawings of a measurement result on noise generated at the time when the motor with the brush shown in FIG. 1 is driven to rotate, and a measurement result on noise generated at the time when a conventional motor with a brush (without the damper member) is driven to rotate, respectively.

FIG. 4A and FIG. 4B are a graph to show a level of noise generated at the time when the motor with the brush 1 shown in FIG. 1 is driven to rotate, in comparison with corresponding data of a conventional motor with a brush (without the damper member); and a graph to show a product lifetime under a condition where the motor with the brush is driven to rotate, in comparison with corresponding data of a conventional motor with a brush (without the damper member), respectively.

FIG. 5 shows explanatory drawings of a motor with a brush relating to other embodiments of the present invention.

### DESCRIPTION OF THE PREFERRED EMBODIMENTS

A preferred embodiment of the present invention is described below with reference to the accompanying drawings.

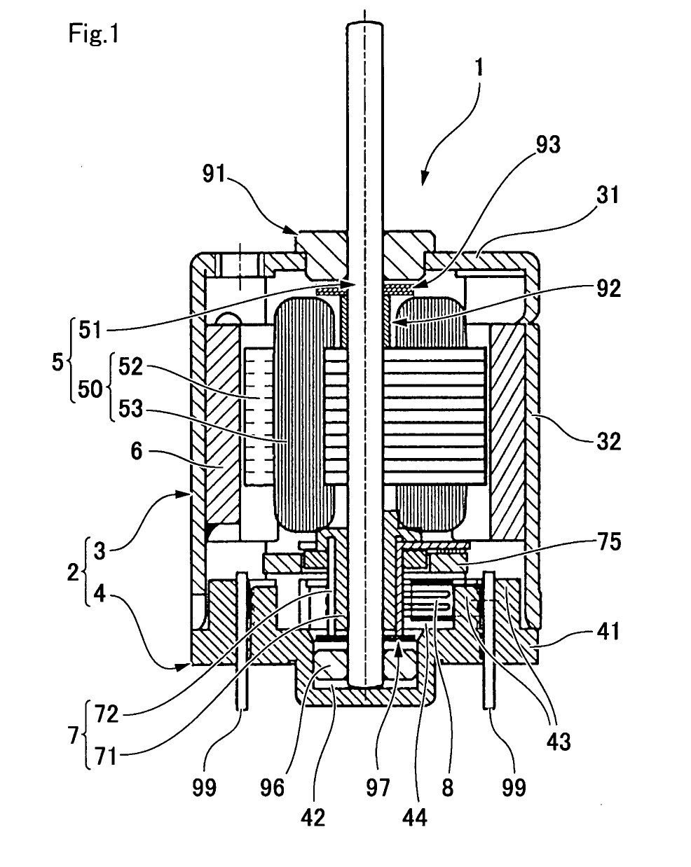

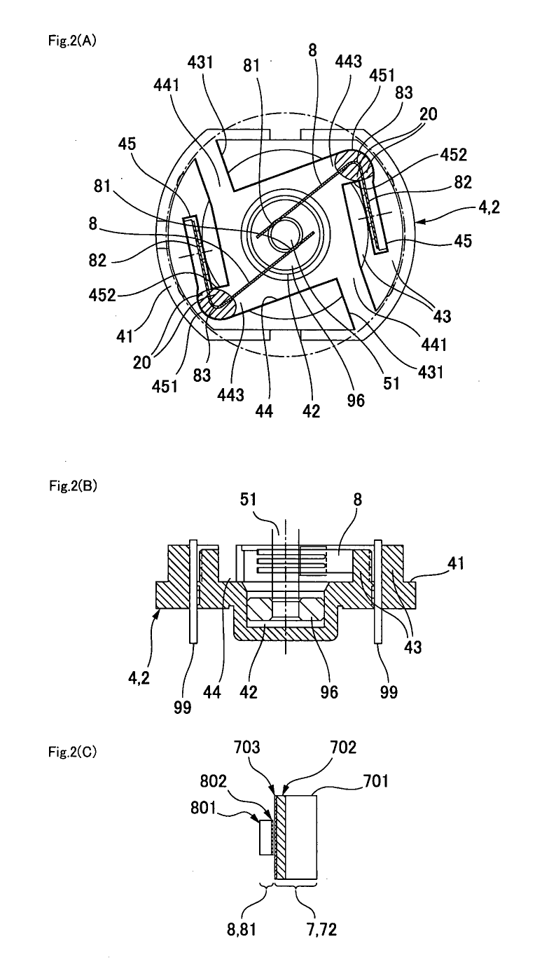

FIG. 1 is a cross-sectional drawing to show a general structure of a motor with a brush to which the present invention is applied. FIG. 2A, FIG. 2B, and FIG. 2C are a plan view drawing and a sectional drawing of a brush and a brush holder extracted from the motor with the brush that FIG. 1 shows, as well as an explanatory drawing of a sliding surface of the brush and the commutator in the motor with the brush that FIG. 1 shows, in due order.

In FIG. 1, a motor with a brush 1 of the present embodiment is a small-sized DC motor equipped with a brush. An output end side of a rotating shaft 51 is protruded from a top end surface 31 of a motor case 3 that is shaped like a cup. In the motor case 3, a core 52 including a number of laminations of magnetic plates is fixed around at a center part in an axial direction of the rotating shaft 51 by a method such as press-fitting and so on. A plurality of salient poles are formed at an outer circumference side of the core 52 at identical angular intervals; and a coil 53 is wound on each core 52, while the core 52 being provided in plural numbers, in order to make up an armature 50. Thus, the armature 50 and the rotating shaft 51 make up a rotor 5 that can rotate as a single component.

In the motor case 3; a permanent magnet 6 shaped like a ring, in which a plurality of poles are magnetized, is fixed onto an inner circumference surface of a cylindrical body section 32 so that the permanent magnet 6 faces an outer circumference surface of the core 52 across a specified clearance. At an open end of the motor case 3, a brush holder 4 made of a polyamide material and so on is installed. Eventually, the motor case 3 and the brush holder 4 make up a stationary side member 2 of the motor with the brush 1.

An upper end side of the rotating shaft 51 is so supported as to be enabled to rotate, by a radial bearing 91 retained with the top end surface 31 of the motor case 3. With regard to the rotating shaft 51, inserted between a section supported by the radial bearing 91 and another section to which the core 52 is fixed are a spacer 92 shaped like a sleeve and a sealing member 93.

A lower end side of the rotating shaft 51 is supported in a thrust direction by a bottom surface of a bottomed cylindrical section 42 formed in the brush holder 4, and furthermore the lower end side of the rotating shaft is so supported as to be enabled to rotate by another radial bearing 96 retained inside the bottomed cylindrical section 42. Moreover, at the lower end side of the rotating shaft 51, another sealing member 97 is inserted at a section adjacent to a part supported by the radial bearing 96.

At a section of the lower end side of the rotating shaft 51, a commutator 7 is so constructed as to rotate together with the rotating shaft 51, and a varistor 75 (an arc-extinguishing element) is located at a position adjacent to the commutator 7. Incidentally, the commutator 7 is equipped with a sleeve 71, which is made of a resin material and fixed to the rotating shaft 51, and a segment 72 placed on an outer circumference surface of the sleeve 71 at identical angular intervals.

As shown in FIG. 1, FIG. 2A, and FIG. 2B, a top end side 81 of a brush 8, while a couple of the brushes being used, elastically contacts an outer circumference surface of the commutator 7. Meanwhile, a base end side 82 of the brush 8 is retained by the brush holder 4. In the meantime, the top end side 81 of the brush 8 is split into 3 parts like teeth of a comb.

In the present embodiment, the brush 8 is constructed with a metal plate including a bent part 83 where the metal plate bends for about 60 degrees on a way from the base end side 82 toward the top end side 81. Then, the top end side 81, which contacts the outer circumference surface of the commutator 7, is formed as a sliding part by using a cladding material containing precious metals. For example, as shown in FIG. 2C, the top end side 81 of the brush 8 is formed with a cladding material in which a silver-palladium alloy 802 is laminated on a surface of a copper layer 801. Meanwhile, the segment 72 of the commutator 7 is constructed with a lamination body including a copper layer 701, a silver-copper-nickel alloy layer 702, and a gold-silver alloy layer 703.

To describe with reference to FIG. 1, FIG. 2A, and FIG. 2B again; formed in the brush holder 4 are a flange section 41 to be laid on the open end of the motor case 3, a thick-wall section 43 which is positioned inside the flange section 41 and a terminal 99 is fixed to, and a concave section 44 which has an almost rectangular profile in a plan view and makes up a space for enabling placement of the brush 8 around the commutator 7. Then, the bottomed cylindrical section 42, which supports the radial bearing 96, is formed at a center position of the concave section 44.

Furthermore, in the rectangular profile of the concave section 44 in the plan view; one couple of opposing corner sections 441 are open to an outside through a cut part 431 of the thick-wall section 43. On the other hand, at the other couple of opposing corner sections 443, a slit 45 is extended into the thick-wall section 43. Each slit 45 is so extended linearly as to go along with a sideline of the rectangular profile according to a bent form of the brush 8. Moreover, an wall surface 451 positioned outside at an inlet part of the slit 45 is so curved as to go along with a form of the bent part 83 of the brush 8.

In the brush holder 4 constructed as described above, the base end side 82 of the brush 8 is fixed to an inside of the slit 45. Furthermore, in the slit 45, the base end side 82 of the brush 8 and the terminal 99 are electrically connected either directly or through a wiring member such as a substrate, a lead wire, and so on.

In a case of the motor with the brush 1 constructed as described above, when the top end side 81 of the brush 8 violently vibrates according to a rotation of the rotor 5 (a rotation of the rotating shaft 51 and a rotation of the commutator 7), mechanical noise is generated. Furthermore, if the top end side 81 of the brush 8 violently vibrates, the segment 72 of the commutator 7 gets abraded and eventually the brush 8 comes to breakage (entire abrasion). That is to say; when the brush 8 vibrates and slides to generate an adhesive component at the segment 72 of the commutator 7, cutting and abrasion accordingly occur due to such movement. Then, each time the brush 8 repeats a motion of contacting the segment 72 of the commutator 7 and separating from the same, a spark occurs so that electric abrasion due to such movement happens.

Therefore, in the present embodiment, as shown in FIG. 2A; a damper member 20 is fixed to the bent part 83 of the brush 8, and meanwhile the damper member 20 is also fixed to the brush holder 4 of a stationary member 2.

More concretely to describe, a resin-base or rubber-base elastic compound is applied so as to cover up both an inside of the bent part 83 of the brush 8 and an inlet part 452 of the slit 45 of the brush holder 4 positioned inside the bent part 83 of the brush 8, and then the elastic compound is hardened to form the damper member 20. As a result, the inside of the bent part 83 of the brush 8 is under a condition of being connected to the inlet part 452 of the slit 45 of the brush holder 4 and a bottom section of the concave section 44 of the brush holder 4 through an intermediary of the damper member 20.

Furthermore, in the present embodiment; a resin-base or rubber-base elastic compound is applied so as to cover up both an outside of the bent part 83 of the brush 8 and the wall surface 451 curved at an outside of the inlet part of the slit 45, and then the elastic compound is hardened to form the damper member 20. As a result, the outside of the bent part 83 of the brush 8 is under a condition of being connected to the wall surface 451 positioned outside the slit 45 of the brush holder 4 and the bottom section of the concave section 44 of the brush holder 4 through an intermediary of the damper member 20.

In the present embodiment, as the resin-base or rubber-base elastic compound, the damper member 20 is formed by using an acrylic modified resin material whose properties are; 14 to 24 Pa·s/23 degrees Celsius in viscosity, approx. 1.24 in density, approx. 29 in hardness (shore hardness A), and 2.4×10⁻⁴ in linear expansion coefficient.

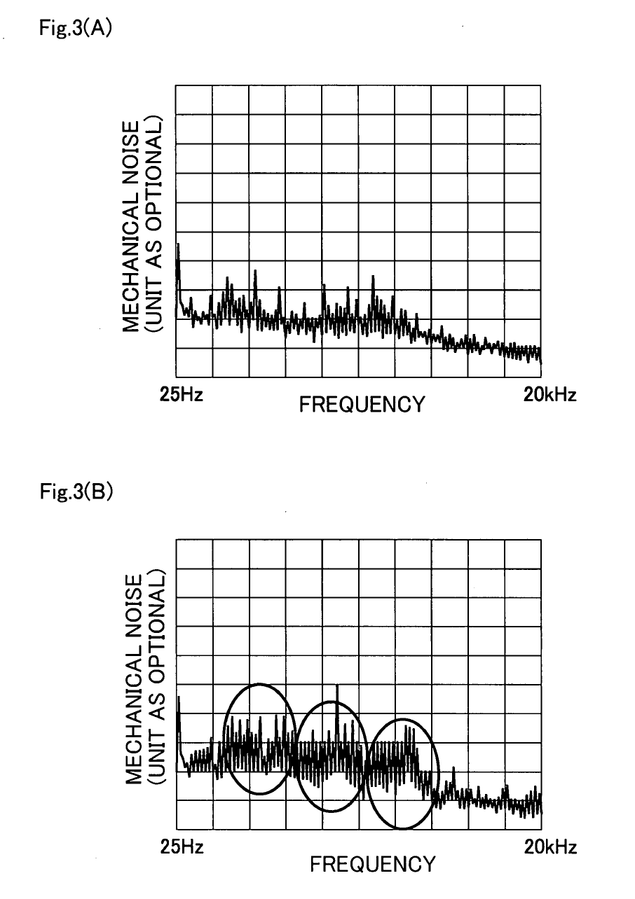

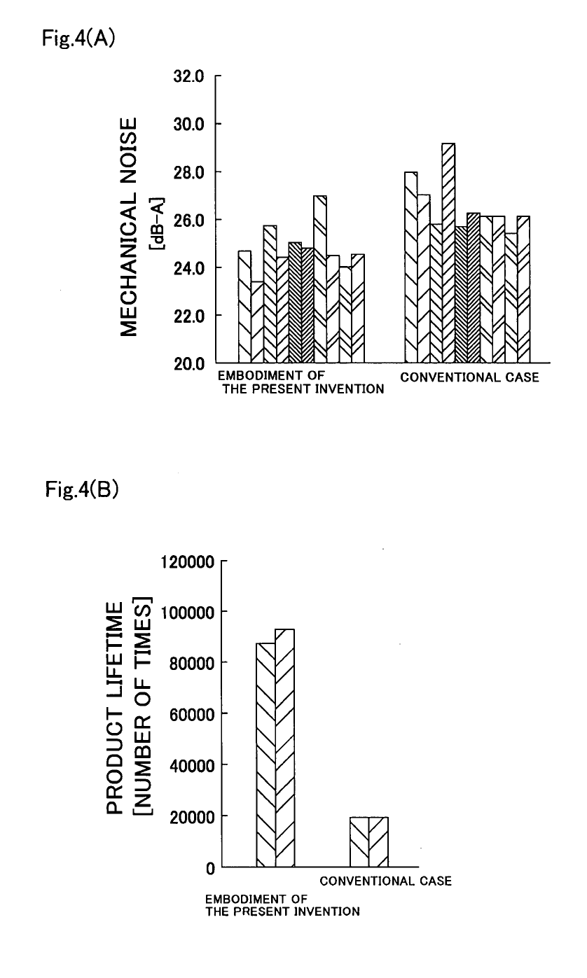

Advantageous effect of the motor with the brush 1 of the present embodiment is described below with reference to FIG. 3 and FIG. 4. FIG. 3A and FIG. 3B are explanatory drawings of a measurement result on noise generated at the time when the motor with the brush 1 of the present embodiment is driven to rotate, and a measurement result on noise generated at the time when a conventional motor with a brush (without the damper member 20) is driven to rotate, respectively. FIG. 4A and FIG. 4B are a graph to show a level of noise generated at the time when the motor with the brush 1 of the present embodiment is driven to rotate, in comparison with corresponding data of a conventional motor with a brush (without the damper member 20); and a graph to show a product lifetime under a condition where the motor with the brush 1 of the present embodiment is driven to rotate, in comparison with corresponding data of a conventional motor with a brush (without the damper member 20), respectively. Incidentally, FIG. 4A shows a result of a test carried out with the number of samples n=10, while FIG. 4B shows a result of a test carried out with the number of samples n=20.

As described with reference to FIG. 1 and FIG. 2; in a case of the motor with the brush 1 of the present embodiment, the damper member 20 is placed for the brush 8, and the damper member 20 is fixed to both the bent part 83 of the brush 8 and the stationary side member 2 (the brush holder 4). Therefore, even when the top end side 81 of the brush 8 vibrates according to a rotation of the rotor 5 (a rotation of the rotating shaft 51 and a rotation of the commutator 7), vibration of the brush 8 can be damped efficiently. Accordingly, as understood with FIG. 3A, FIG. 3B, and FIG. 4A; mechanical noise generated due to the vibration of the brush 8 can be reduced. That is to say; in a case of a conventional motor with a brush (without the damper member 20), large mechanical noise is generated at frequency ranges circled in FIG. 3B: However, in the case of the motor with the brush 1 of the present embodiment, such large mechanical noise as generated in the case of the conventional motor with the brush is not generated, as FIG. 3A shows. Therefore, it is possible to materialize a silent unit and furthermore a non-energizing time can be eliminated.

Moreover, in the case of the motor with the brush 1 of the present embodiment; as much as vibration of the brush 8 is controlled, abrasion of the brush 8 and the commutator 7 can be controlled. Accordingly, it is possible to materialize a long product lifetime of the motor with the brush 1 as shown in FIG. 4B.

Furthermore, in the motor with the brush 1 of the present embodiment, the damper member 20 is fixed to both the bent part 83 of the brush 8 and the stationary side member 2 (the brush holder 4). Therefore, when the present embodiment is compared with a case where the damper member is fixed only to an outside of a base part of the brush 8 and its neighboring part but not to the stationary side member, it is possible for the present embodiment to significantly improve a vibration damping performance of the brush 8. As a reason for the effect, it is considered that; in the present embodiment, vibration of the brush 8 that occurs at a plurality of frequency ranges is effectively prevented by elasticity of the damper member 20 fixed to the bent part 83 of the brush 8 as well as elasticity of the damper member 20 existing between the bent part 83 of the brush 8 and the stationary side member 2 (the brush holder 4), in addition to elasticity that the brush 8 itself has and elasticity that the bent part 83 of the brush 8 has.

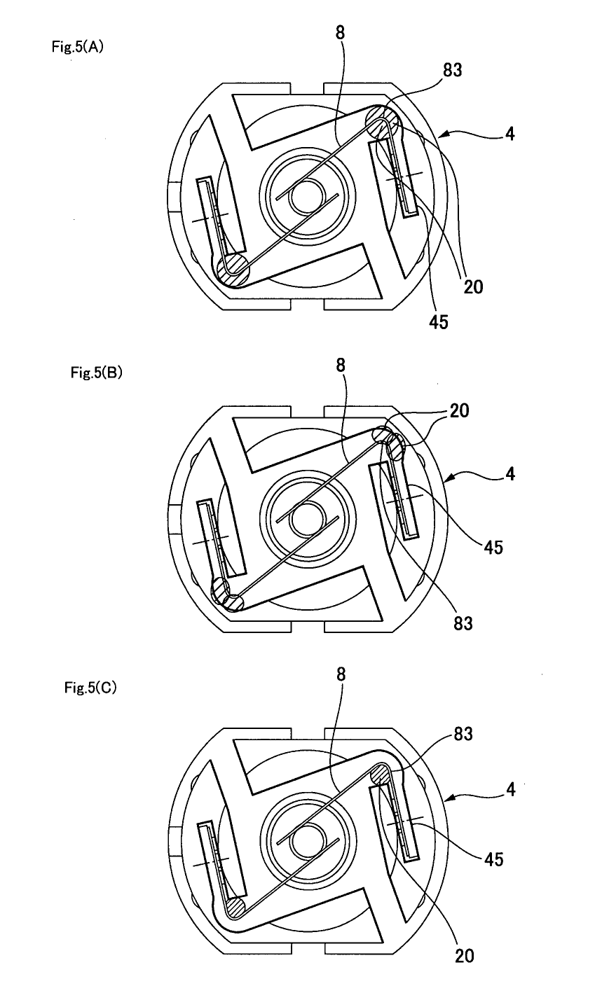

Moreover, in the motor with the brush 1 of the present embodiment, the damper member 20 is fixed to both the inside and outside of the bent part 83 of the brush 8. Therefore, when the present embodiment is compared with a case where the damper member 20 is placed only to an outside of a base part of the brush 8 and its neighboring part, or another case where the damper member 20 is fixed only to one of an inside and an outside of the bent part 83 as described later with reference to FIG. 5B and FIG. 5C, it is possible for the present embodiment to significantly improve a vibration damping performance of the brush 8. As a reason for the effect, it is considered that; when the damper member 20 is fixed to both the inside and outside of the bent part 83, a part of the damper member 20 fixed to the inside of the bent part 83 and another part of the damper member 20 fixed to the outside of the bent part 83 each carry out compression and extension so as to control vibration of the damper member 20 according to each displacement in a direction with which the bent part 83 opens and another direction with which the bent part 83 closes.

Furthermore, in the present embodiment, since a resin-base or rubber-base elastic compound is applied and then hardened to form the damper member 20, it is easy to fix the damper member 20 in each clearance at both the inside and the outside of the bent part 83 to the stationary side member 2.

Still further, if the damper member 20 is formed at both the inside and the outside of the bent part 83 of the brush 8, it is possible to prevent variation between the inside and the outside from occurring.

In the embodiment described above, as shown in FIG. 5A, the damper member 20 is fixed in each clearance at both the inside and the outside of the bent part 83 to the stationary side member 2. However, as shown in FIG. 5B, even when the damper member 20 is fixed only between the outside of the bent part 83 and the stationary side member 2, such an embodiment can improve a vibration damping performance of the brush 8; being compared with a case where the damper member 20 is not placed, or another case where the damper member 20 is placed only at an outside of a base part of the brush 8 and its neighboring part but not fixed to the stationary side member 2.

Furthermore, as shown in FIG. 5C, even when the damper member 20 is fixed only between the inside of the bent part 83 and the stationary side member 2, such an embodiment can improve a vibration damping performance of the brush 8; being compared with a case where the damper member 20 is not placed, or another case where the damper member 20 is placed only at an outside of a base part of the brush 8 and its neighboring part but not fixed to the stationary side member 2, or still another case where the damper member 20 is fixed only between the outside of the bent part 83 and the stationary side member 2 as shown in FIG, 5B.

By the way, each of the embodiments described above shows an example where a resin-base or rubber-base elastic compound is applied and then hardened to form the damper member 20. However, it is also possible to apply a structure in which a resin-base or rubber-base elastic member, as the damper member 20, is fixed to both the bent part of the brush 8 and the stationary side member.

Furthermore, in the embodiments described above, the damper member 20 is fixed to the brush holder 4 of the stationary side member 2, but the damper member 20 can also be fixed to the motor case 3 (the stationary side member 2).

The present invention is not to be considered limited in scope by the preferred embodiment described in the specification. Additional advantages and modifications, which readily occur to those skilled in the art from consideration and practice of this invention are intended to be within the scope and spirit of the following claims:

We claim:

1. A motor with a brush comprising:
a rotor;
a commutator that is rotatable together with the rotor;
a brush; and
a stationary side member that retains a base end side of the brush in such a manner that a top end side of the brush elastically contacts an outer circumference surface of the commutator, and furthermore retains a permanent magnet in such a manner that the permanent magnet faces the rotor;
wherein the brush is equipped with a bent part on a way from the base end side toward the top end side, as well as a damper member fixed to both the bent part of the brush and the stationary side member.

2. The motor with the brush according to claim 1,
wherein the damper member is fixed to both an inside and an outside of the bent part.

3. The motor with the brush according to claim 1,
wherein the damper member is fixed to the inside of the bent part.

4. The motor with the brush according to claim 1,
wherein the damper member is fixed to the outside of the bent part.

5. The motor with the brush according to claim 1,
wherein the damper member is one of a resin-base elastic compound and a rubber-base elastic compound that is applied so as to cover up both the bent part and the stationary side member, and then hardened.

6. The motor with the brush according to claim 1,
wherein the stationary side member comprises at least a brush holder to retain the base end side of the brush and a case to retain the permanent magnet, and the damper member is fixed to the brush holder of the stationary side member.

7. The motor with the brush according to claim 6,
wherein the brush holder is equipped with a slit to fix the base end side of the brush, and the damper member is fixed to an inlet part of the slit of the brush holder.

8. The motor with the brush according to claim 7,
wherein the slit is extended linearly according to a shape of the base end side of the brush, and a wall surface at an outside of the inlet part of the slit is formed to be a curved wall surface according to a shape of the bent part, and the damper member is fixed to the curved wall surface of the brush holder.
